(19) United States
(12) Patent Application Publication
(10) Pub. No.: US 2024/0011225 A1
(43) Pub. Date: Jan. 11, 2024

(54) INSULATION MATERIAL, INSULATION PRODUCT, LAYER STUCTURE, CONSTRUCTION AND METHOD OF MANUFACTURING INSULATION MATERIAL

(71) Applicant: Fiberwood Oy, Muurame (FI)

(72) Inventors: Jukka Pitkälä, Muurame (FI); Jyri Pitkälä, Leppävesi (FI)

(21) Appl. No.: 18/035,177

(22) PCT Filed: Nov. 9, 2021
(86) PCT No.: PCT/FI2021/050759

§ 371 Date: May 3, 2023

(51) Int. Cl. D21H 17/23; D21H 11/00; D21H 21/34; D21F 11/00; E04B 1/80; B27N 3/04; B27N 9/00

(52) U.S. Cl. CPC D21H 17/23; D21H 11/00; D21H 21/34; D21F 11/002; E04B 1/80; B27N 3/04; B27N 9/00

(57) ABSTRACT

The invention concerns an insulation material (10) comprising a wood-derived material (11) and a fire retardant (13). The wood-derived material is in the insulation material as a non-separated fiber fraction (14) and as a separated fiber fraction (15) and the insulation material is a combination of said fractions with the fire retardant without separate polymer components (28). In addition, it is also an object of the invention to provide an insulation element, a layer structure, a construction and a method of producing an insulation material.

It is an object of the invention to provide an insulation material comprising a wood-derived material and a fire retardant. In addition, it is an object of the invention to provide an insulation product, layer structure, construction and a method for producing an insulation material.

Various heat insulation materials comprising wood-derived plant fiber are known in the field of construction materials. One example of this is a blown wool made for example of recycled fiber. More solid heat insulation materials are also known, which can be treated for example as boards or mats. One such is the heat insulation board marketed by Hunton Fiber AB under product name Nativo. It contains wood fiber, synthetic biopolymer fiber and fire retardant [1].

Due to the polymer i.e. plastic involved, the above referred heat insulation material cannot be said to be fully plant fiber derived product. Chemical compounds may evaporate into the air from synthetic polymers. They can be released from the structures into the living spaces and thus into the air we breath. The substances may be allergenic in different ways.

In addition, synthetic polymer in insulations may be associated with health risks also for example in connection with the installation of the heat insulation material. It is typical that the dimensions of the insulation elements do not always fit as such to the structure to be insulated, wherein they have to be cut at the construction site to a size and/or shape suitable for the structure. Dust from the cutting enters the air and those handling the insulation may need to protect themselves from it, at least in terms of the air they breathe. The effects of a long-term exposure are necessary not yet well enough understood and, thus, potential occupational safety risk may be associated with insulations.

It is an object of the invention to provide an insulation material and an insulation product of a corresponding material, which improve the problems of the prior art for example in connection with the installation of insulations and/or the health during use. The characteristic features of the insulation material according to the invention are presented in claim 1, the insulation product in claim 12 and the method in claim 13.

The insulation material according to the invention and the insulation product made therefrom can be said to be genuinely completely derived from wood fiber without polymer components, i.e. plastic. Preferably, the insulation material also does not contain other binders, especially synthetic binders. Thus, in addition to the wood-derived material, the insulation material and especially the insulation product comprise at most, for example, a fire retardant.

The insulation material according to the invention can be produced, for example, by a foam forming method. Thus, in addition to the wood-derived material and a fire retardant, the insulation material comprises at most small amounts of a foaming chemical. The foam forming method is one exemplary way to provide internal and external bonds between fractions and, thus, the cohesion of the insulation material.

The insulation material is completely natural without polymer components, i.e. for example synthetic polymers, and thus, its health effects in the operating and installation situations are better tolerated since the substances of the insulation material are of natural origin and their health effects are less harmful or at least better known than for example in insulations comprising synthetic polymers or other synthetic binders. Other additional advantages obtained by the invention are apparent from the detailed description of the invention and characteristic features are apparent from the claims.

The invention, which is not restricted to the following embodiments, will be described in more detail with reference to the accompanying drawings, in which

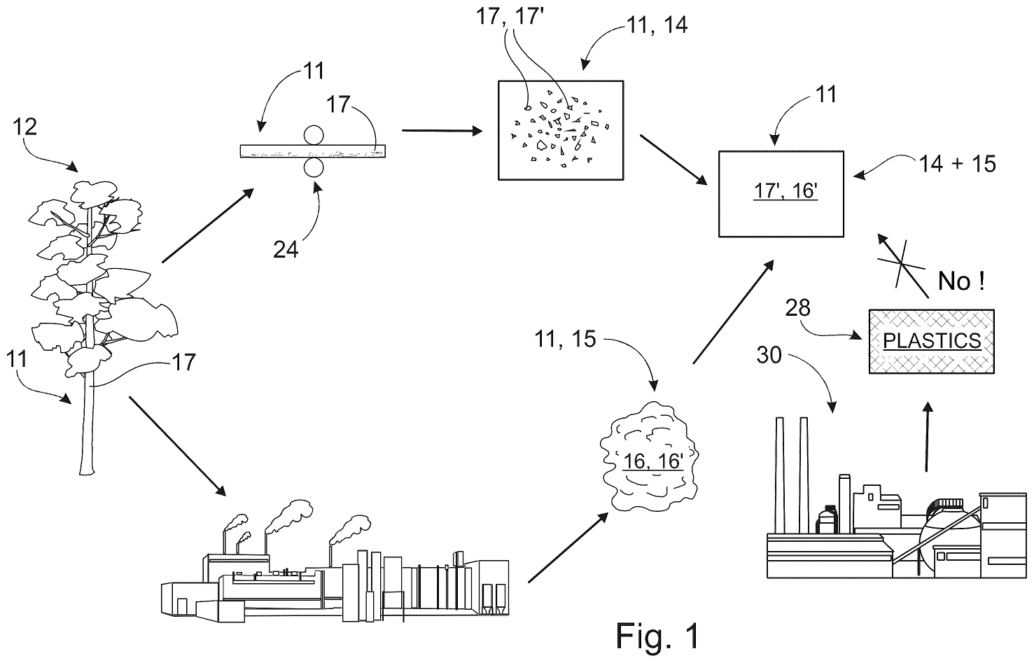

FIG. 1 shows an example of the raw materials of the insulation material at a principle level,

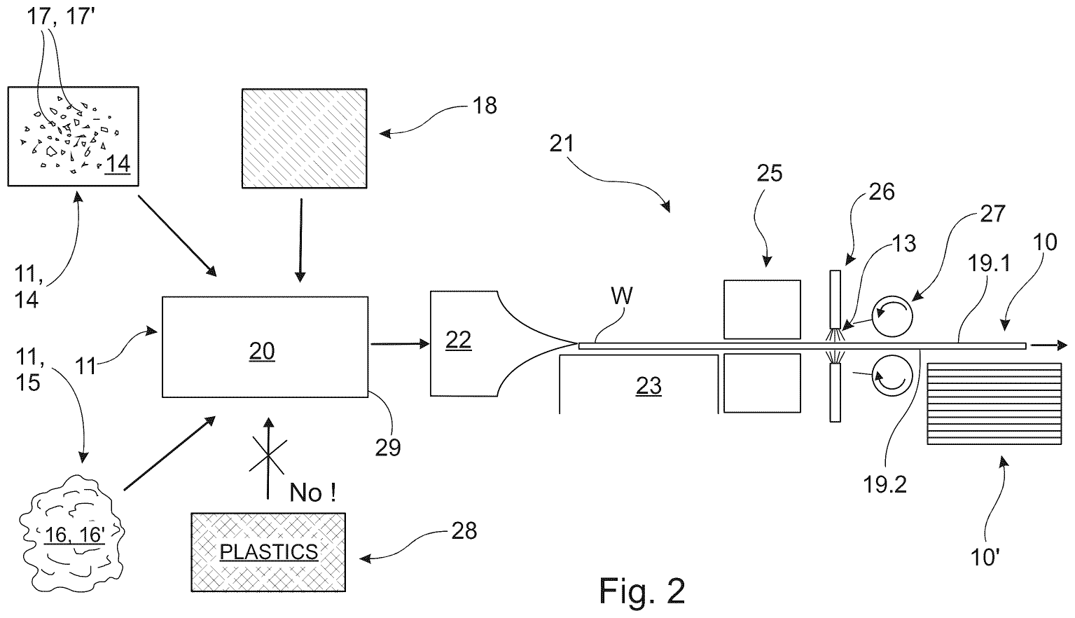

FIG. 2 shows an example of producing the insulation material,

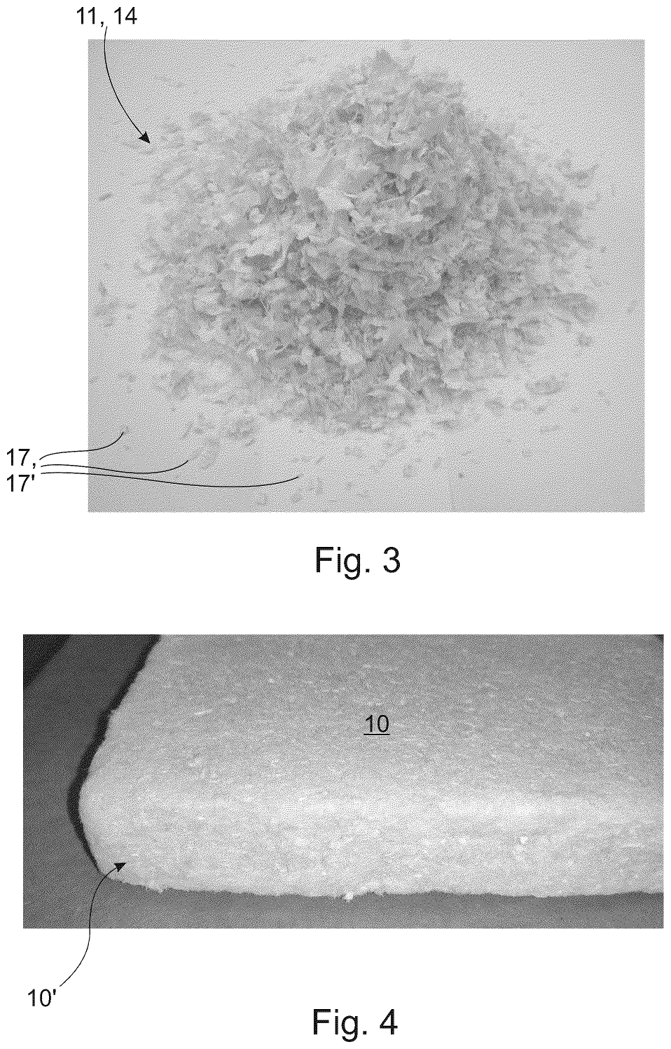

FIG. 3 shows an example of a wood dust used for producing the insulation material and

FIG. 4 shows an example of a cross section of the insulation material according to the invention.

FIG. 1 shows the origin of the wood fiber derived raw materials 14, 15 of the insulation material according to the invention as a schematic diagram, and FIG. 2, in turn, shows an example of a production method of the insulation material 10 according to the invention. The insulation material 10 comprises wood-derived material 11 and a fire retardant 13. Wood-derived material 11 is in the insulation material 10 as two fractions 14, 15. The wood-derived material 11 can be said to be in the insulation material 10 as a non-separated fiber fraction 14 and as a separated fiber fraction 15. Thus, the wood-derived material 11 can in particular be said to be a fiber material derived from wood 12. Further, the insulation material 10 according to the invention is the combination i.e. mixture of said wood-derived fractions 14, 15 with the fire retardant 13 without separate polymer components 28, such as for example synthetic polymers, belonging to the insulation material 10. In other words, the insulation material 10 does not include for example any plastic coming from oil refining process 30, i.e. products of petrochemistry.

The non-separated fiber fraction 14 of the insulation material 10 contains wood material 17 in a particulate form. The particulate wood material 17 is particles mechanically formed from the material 11 derived from wood 12. Examples of production methods are grinding, planing (shaving) 24 or milling of the wood material 17. The particles can be wood dust, sawdust or shavings, more particularly for example plane shavings, either as such or as refined in a selected manner.

According to one embodiment, the non-separated fiber fraction contains wood material 17 in a particulate form, wherein the particle size of the wood material is preferably 0.005-30 mm, more preferably 0.01-10 mm, for example 0.01-8 mm.

As an example of a suitable shaving can be mentioned shavings used as a litter for animals, such as plane shaving. As a commercial example of this a litter shaving marked by Versowood Oy by name “Verso Hirnu”-littering can be mentioned. FIG. 3 shows a picture of such shaving. The wood material 17, from which the wood particles are formed, can be for example pine or spruce. According to an embodiment, the wood particles are screened wood particles.

According to an embodiment, the wood particles are also dry. Size of the wood particles in the case of said plane shaving is >1 mm, in particular 2-8 mm, such as for example 6 mm and it does not contain chips, dust or sticks. Thus, the wood particles can be said to be uniform and flexible elastic shavings.

The wood particles also have an absorption capacity. According to one embodiment, the wood particles can be either crushed or some other way refined plane shavings, wherein the particle size can be further decreased compared to that it is in the plane shaving as such. One way is to run the plane shaving through a hammer mill, for example, one or more times.

In another embodiment, the wood particles are wood dust or sawdust. In this case, size of the wood particles is typically 0.005-10 mm, preferably 0.01-8 mm, for example 0.05-2.5 mm.

In one embodiment, the particle size of the wood dust is about 10-50 μm.

In one embodiment, the particle size of the sawdust is about 0.05-4 mm, for example 3 mm.

Particle size of the wood particles is expressed as a screened particle size.

Thus, the non-separated fiber fraction 14 can be said to be wood material 17 derived from wood 12, in which wood material the fibers are attached to each other in the wood particle as they are naturally in the wood material 17. It can also be said that no such mechanical and/or chemical wood processing related operations are applied to the wood particle, which operations would have detaching or breaking effect on the fibers inside the wood particle unit.

According to one embodiment, the non-separated fiber fraction 14 can be said to be so called non-fibrous material, preferably wood material. In general, in non-fibrous material the dimensions of the particles can be different in different directions of the particle, wherein the non-fibrous material typically has some average particle size, as described above.

Proportion of the wood material 17 as such in the insulation material 10 is relatively high. The wood material 17 as such is an inexpensive material. One particular advantage provided by the wood material 17 in the insulation material is an improved moisture transfer in the structure in which the insulation material is present. The wood particles of the insulation material 10 absorb moisture and release it, depending on circumstances.

The separated fiber fraction 15 of the insulation material 10, in turn, comprises wood-derived pulp, i.e. mechanical, chemimechanical and/or chemical pulp 16 prepared from the wood material 17. Thus, it is also possible to speak of wood material processed by wood processing industry 31. As examples, a mention can be made of refined pulp, ground pulp or chemical pulp, such as cellulosic pulp. Corresponding processes then involve refining or grinding of the wood material 17 or cooking the shavings derived from wood 12 in order to separate the fibers from each other in a desired manner from the wood material 17. In addition to cellulosic pulp production, also in the case of refined pulp and ground pulp, in addition to mechanical stress, chemicals, liquids, pressure and/or heat, for example, may have been involved in the pulp production in a manner known per se. An example of a suitable mechanical pulp may be CTMP pulp 16′. It can be produced by a chemi-thermomechanical pulp process (CTMP). Its purpose is to produce rigid mechanical pulp from wood chips using chemicals, heat and mechanical energy. In the case of cellulosic pulp, in turn, for example substances which are present in the wood material 17 in addition to the fibers have been separated from the wood in a manner known per se. As examples, a mention can be made of lignin and extracts. Mechanical pulp comprises these substances. However, the separated fiber fraction 15 is characterized in that the wood fibers are in one or more components forming the fraction more or less separated from each other in a way that is not inherent for the wood material 17 used as a raw material for the components in the fraction 15.

Thus, according to one embodiment, the separated fiber fraction 15 can be said to be a fibrous matter, and since it is preferably wood material 17 derived from wood 12, it can also be called wood fiber. In general, a fibrous material has some average fiber length. The fiber length varies for example based on the fiber source.

According to one embodiment, the average fiber length of the wood fibers contained in the separated fiber fraction 15 is preferably 0.5 mm-6 mm, more preferably 1 mm-4 mm, for example 1.5 mm-2.5 mm. The length of the wood fibers can be measured for example by microscope or optical scanner. Typically, the fiber length is measured by a fiber analyzer, such as by Valmet Fiber Image Analyzer or L&W Fiber Tester Plus. Fiber length can vary based on the quality and patch.

According to one embodiment, the fiber length of the separated fiber fraction 15 can affect for example strength properties of the material. Typically, a longer fiber provides a higher strength for the material.

Based on the above, the non-separated and separated fiber fractions 14, 15 are determined by the state of fibers in the raw material of the components of the fractions 14, 15 i.e. in wood material 17, from which the components of the fractions 14, 15 are produced. In the wood material 17, the fibers can be said to be in a non-separated from. The separated fiber fraction 15 is preferably mechanical and/or chemimechanical pulp. It provides, for example, a higher compressive strength in the insulation material 10 compared to, for example, pure chemical pulp, such as cellulosic pulp.

The insulation material 10 may comprise the wood material 17 as a separated fiber fraction 15 expressed as percentage by weight 10-85%, in particular 30-55%, and more particularly 30-45%. Preferably, the insulation material 10 comprises the wood material 17 as a separated fiber fraction 15 expressed as percentage by weight 30-70%, preferably 40-60%. The fraction 15 may comprise one or several components, such as cellulosic pulp, CMTP 16′, ground pulp and/or refined pulp. Thus, the insulation material 10 may comprise the wood material 17 as a non-separated fiber fraction 14 expressed as percentage by weight 10-85%, in particular 40-60%, and more particularly 50-60%. Preferably, the insulation material 10 comprises the wood material 17 as a non-separated fiber fraction 14 expressed as percentage by weight 30-70%, preferably 40-60%. The component of fraction 15 is for example wood dust 17′. Fire retardant 13 is then present in the insulation material 10 expressed as percentage by weight 3-20%, for example 5-10%, in particular 4-8%. According to one embodiment, the fire class of the insulation material 10 is E.

The insulation material 10 is suitable to be produced by a foam forming method 21. FIG. 2 shows a rough diagram about the production of the insulation material and the insulation products 10′ therefrom. In this case, the insulation material 10 comprises in addition to the above mentioned fractions 14, 15 also a foaming chemical 18, the amount of which is for example less than 1%. For example SDS or chemicals sold under the trade name Tween20, which are biodegradable materials, can be used as foaming chemical 18. In the production process of the insulation material 10, an aqueous fiber dispersion formed by fiber fractions 14, 15 without synthetic polymers 28, more generally polymer components, is foamed with a foaming chemical 18 and vigorous mixing in a container 29, from which container it is pumped to the nozzle/headbox 22. The nozzle/headbox 22 distributes the fiber foam evenly on top of the wire of the wire section 23. An evenly distributed insulation material layer is formed, in which layer the fractions 14, 15 are distributed in the perpendicular direction of the insulation material 10 through the whole material. In other words, in foam forming, the fractions 14, 15 are mixed so that the end product, i.e. the insulation product 10′, produced from them is porous and cohesive.

Preferably, the insulation product has a non-settling structure, in which the fire retardant stays well attached. The fire retardant is distributed in the insulation material especially based on its weight.

In the wire section 23, water is removed from the fiber foam by means of, for example, gravity and a small vacuum. In addition, heating can also be used for dewatering. After the wire section 23, the web W goes to the drying level 25.

There, water is evaporated with different drying techniques. After the drying level 25, dry matter content of the product 10 is about 90%, more generally 85-95%. From the drying level 25, the web W goes to finishing. Fire retardant 13 is added for example by spraying, brushing, foam coating or curtain coating on to the surfaces 19.1, 19.2 of the insulation material 10 during the production process by the means 26 or only after that. It may happen for example towards the end of it, before and/or after drying 25. Fire retardant 13 may be some known salt compound or organic compound. As an examples of fire retardants 13 a mention can be made of magnesium hydroxide, magnesium sulphate, aluminum hydroxide, aluminum trihydrate, aluminum sulphate. The fire retardant may equally be for example some phosphate-based. The fire retardant may also be chosen for example from the group of ammonium phosphates, borate, boric acid and iron phosphate and mixtures thereof. Density of the insulation material 10 in generally 10-100 kg/m³, especially 30-50 kg/m³, in particular 35-45 kg/m³, such as for example 40 kg/m³. Finally, the insulation product 10′, i.e. insulation boards or mats, is cut by means 27 from the insulation material web W. Thickness of the end product, i.e. panel like insulation product 10′, can be for example 5-1000 mm, such as 10-300 mm, in particular 50-200 mm.

In the tests of the Pilot phase, it has been observed that the higher the amount of CTMP 16′ is, the higher is the compression strength of the insulation material 10. Thus, the amount of CTMP 16′ in the insulation material 10 is preferably at least half, such as 50-85%, or over half, for example 65-75% and the amount of non-separated fiber fraction 14, such as wood dust 17′ or sawdust, is at most half, for example 10-50%, for example 40-50%. With regard to reversibility, the results are similar. In terms of reversibility, the optimal ratio of fractions 14, 15 in the insulation material 10 can, thus, be closer to 50:50. Such ratios of fractions 14, 15 are not, however, necessary the most desirable ones concerning the end product. In the end product, proportion of wood particles is preferably higher than that of CTMP 16′ but in a way that the desired product characteristics are still obtained.

Thermal conductivity of the insulation material 10 is typically 0.0250-0.0450, for example 0.030-0.040, in particular 0.036-0.038 W/(m·K). Typical application of the foam formed wood fiber based insulation material 10 is acting as a heat insulation in structures. For example in constructions, the heat insulation material, for example placed in the interior structures of the construction, prevents heat transfer in a manner known per se from the interior of the construction outwards and also other way around.

Thus, it is also an object of the invention to provide a layer structure comprising surface layers on opposite outer sides of the layer structure, between which surface layers there are one or several insulation layers formed by the insulation products 10′. At least part of the insulation products 10′ is the insulation material 10 according to the invention.

Further, it is also an object of the invention to provide a construction comprising several layer structures for example on the walls of the construction. At least one of layer structures being the layer structure according to the invention.

### REFERENCES

[1]: Vàrme-& fuktegenskaper hos biobaserade isoleringsmaterial, Robert Oscar Bálint Palmgren|LTH| Lunds universitet.
http://lup.lub.lu.se/luur/download?func=downloadFile&recordOI de=8991185&fileOId=8992313

(PDF-document downloaded 07.09.2020, print of the document is in the possession of the applicant.)

1-18. (canceled)

19. An insulation material comprising:
a wood-derived material; and
a fire retardant,
wherein the wood-derived material comprises a non-separated fiber fraction and a separated fiber fraction, and
wherein the insulation material is a combination of said non-separated and separated fractions with the fire retardant without separate polymer components.

20. The insulation material according to claim 19, wherein:
the non-separated fiber fraction comprises wood material in a particulate form, and
the separated fiber fraction comprises wood-derived mechanical and/or chemical pulp.

21. The insulation material according to claim 19, wherein the insulation material comprises:
10-85 weight-% of the separated fiber fraction;
10-85 weight-% of the non-separated fiber fraction; and
5-10 weight-% of the fire retardant.

22. The insulation material according to claim 19, wherein the insulation material is produced by foam forming, and wherein the insulation material further comprises a foaming chemical in an amount of less than 1 weight-%.

23. The insulation material according to claim 19, wherein the density of the insulation material is 10-100 kg/m³.

24. The insulation material according to claim 19, wherein the thermal conductivity of the insulation material is 0.0250-0.045, W/(m K).

25. The insulation material according to claim 19, wherein the fire class of the insulation material is E.

26. The insulation material according to claim 20, wherein the wood material in a particulate form comprises elastic shavings.

27. The insulation material according to claim 20, wood material in a particulate form is screened.

28. The insulation material according to claim 19, wherein the dry matter content of the insulation material is at least 85%.

29. The insulation material according to claim 19, wherein the fire retardant is on a surface of the insulation material.

30. The insulation material according to claim 19, wherein the non-separated fiber fraction comprises wood material in a particulate form, and wherein the particle size of the wood material in particulate form is 0.005-30 mm.

31. The insulation material according to claim 19, wherein the fiber length of the wood fibers contained in the separated fiber fraction is 0.5-6 mm.

32. The insulation material according to claim 19, wherein the insulation material comprises, calculated from the total weight of the insulation material:
30-70 weight-% of the separated fiber fraction;
30-70 weight-% of the non-separated fiber fraction; and
3-15 weight-% of the fire retardant.

33. An insulation product cut to size and comprising the insulation material according to claim 1.

34. A method for producing an insulation material, the method comprising:
producing the insulation material from a wood-derived material, wherein the insulation material is produced by a foam forming a non-separated fiber fraction and a separated fiber fraction without separate polymer components.

35. A layer structure comprising surface layers on opposite sides of the layer structure, between which surface layers there are one or more insulation layers comprising the insulation material according to claim 1.
